(19) United States
(12) Patent Application Publication
(10) Pub. No.: US 2025/0075333 A1
(43) Pub. Date: Mar. 6, 2025

(54) LASER SYSTEM FOR LASER CLADDING WITH A POWDER JET HAVING HARD-MATERIAL PARTICLES

(71) Applicant: TRUMPF Laser- und Systemtechnik GmbH, Ditzingen (DE)

(72) Inventors: Tim Hesse, Ditzingen (DE); Björn Sautter, Leonberg (DE); Andreas Scholz, Taunusstein (DE)

(21) Appl. No.: 18/923,759

(22) Filed: Oct. 23, 2024

Related U.S. Application Data
(63) Continuation of application No. PCT/EP2023/061554, filed on May 2, 2023.

(30) Foreign Application Priority Data
Apr. 29, 2022 (DE) 10 2022 110 570.9

(51) Int. Cl. C23C 24/10; B23K 26/14; B23K 26/144; B23K 26/342; B23K 103/04; B23K 103/08; F16D 65/02; F16D 65/12

(52) U.S. Cl. CPC C23C 24/106; B23K 26/144; B23K 26/1464; B23K 26/342; C23C 24/103; F16D 65/127; B23K 2103/05; B23K 2103/08; F16D 2065/132; F16D 2250/0046

(57) ABSTRACT

A laser system for laser metal deposition includes a laser source for generating a laser beam having a wavelength in a range between 0.4 μm and 1.5 μm, and a jet nozzle for directing the laser beam at a workpiece surface and for directing a powder jet including a pulverulent material at the laser beam and at the workpiece surface. The laser beam exiting from the jet nozzle has a reduced intensity in a core region in comparison with a border region. The pulverulent material includes hard-material particles.

### CROSS REFERENCE TO RELATED APPLICATIONS

This application is a continuation of International Application No. PCT/EP2023/061554 (WO 2023/209249 A1), filed on May 2, 2023, and claims benefit to German Patent Application No. DE 10 2022 110 570.9, filed on Apr. 29, 2022. The aforementioned applications are hereby incorporated by reference herein.

### FIELD

Embodiments of the present invention relate to a laser system and a method for laser metal deposition.

### BACKGROUND

The technique of laser metal deposition is used in the fields of repair, coating and joining technology, for example. A distinction can be made between conventional techniques (Laser Metal Deposition (LMD), Direct Metal Deposition (DMD) or Direct Energy Deposition (DED)) and high-speed laser metal deposition (HS-LMD or Extreme High-Speed Laser Deposition (EHLA)).

In the case of conventional laser metal deposition, a weld pool 16 is generated on the surface 12 of a workpiece 10 by means of a laser beam 30, as schematically illustrated in FIG. 1a. A pulverulent filler material 20 is introduced into the weld pool 16 through a powder nozzle arranged coaxially with or laterally in relation to the laser beam 30 by way of an inert conveying or carrier gas. Before impinging on the weld pool 16, the powder particles 20, or at least some of the powder particles 20, are subjected to laser light in an interaction zone 40 with the laser beam 30. With the LMD method, the input of energy into the workpiece 10 by means of the laser beam 30 is generally greater than the input of energy into the powder particles 20. The powder particles 20 are therefore generally only melted after impinging in the weld pool 16. If the melt solidifies, a consolidated layer bonded by melt metallurgy is formed. A coaxial powder-nozzle arrangement generates a focused powder gas jet. In order to create a defect-free layer, in principle the interaction time with the powder particles 20 in the weld pool 16 needs to be long enough for temperature equalization to take place between the particles 20 and the melt 16 and for the particles 20 to transition to the liquid state. This limits the speed of the LMD process. The large amount of laser radiation impinging on the workpiece results in the production of a large mixing and heat-affected zone 14 (WEZ).

By contrast to the conventional LMD process, in the case of HS-LMD (cf. FIG. 1b) the pulverulent filler material 20 is deliberately heated to temperatures around the melting point or higher above the workpiece surface 12. Owing to a sufficiently large interaction zone 40 between the laser beam 30 and the powder-gas jet, the powder 20 is heated to such an extent that it substantially directly forms a solid, in particular melt-metallurgical connection with the workpiece 10 on the workpiece surface 12, which is likewise preheated by the laser beam 10. This makes it possible to realize considerably higher feed rates, up to 500 m/min, than in the case of conventional laser metal deposition (0.5 m/min to 2 m/min), since there is no need to spend time on melting the particles 20 in the weld pool 16. Reducing the input of energy into the workpiece 10 causes a considerable reduction in the heat-affected zone 14 and the weld pool 16. This also makes it possible to coat temperature-sensitive materials such as aluminum and cast alloys by means of HS-LMD. HS-LMD is used for the coating of in particular rotationally symmetrical components, for example brake discs or plain bearings. For material deposition by means of HS-LMD, the component is rotated and the processing head for supplying the laser beam and the powder is moved in particular in a straight line perpendicularly or parallel to the axis of rotation of the component. In this way, a spiral-shaped or helical bead, which forms a coating face at the end, can be created.

HS-LMD methods are described, for example, in DE 10 2011 100 456 B4 or in DE 10 2018 130 798 A1.

### SUMMARY

Embodiments of the present invention provide a laser system for laser metal deposition. The laser system includes a laser source for generating a laser beam having a wavelength in a range between 0.4 μm and 1.5 μm, and a jet nozzle for directing the laser beam at a workpiece surface and for directing a powder jet including a pulverulent material at the laser beam and at the workpiece surface. The laser beam exiting from the jet nozzle has a reduced intensity in a core region in comparison with a border region. The pulverulent material includes hard-material particles.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIGS. 1a and 1b show schematic representations of an LMD process and an HS-LMD process according to some embodiments;

FIGS. 2a, 2b, 2c, and 2d show schematic representations of different laser beams and the resulting interaction sections of a pulverulent material with the respective laser beam, according to some embodiments;

FIG. 3 shows the process window width with respect to the laser power depending on the beam profile of the laser beam, according to some embodiments;

FIG. 4a shows a beam profile with an annular intensity maximum in cross-section, according to some embodiments;

FIG. 4b shows a linear beam profile with a leading and a trailing intensity maximum, according to some embodiments;

FIGS. 5a, 5b, and 5c show a workpiece to which a two-layer system has been applied according to some embodiments;

FIG. 6 shows a distortion of a cooled workpiece according to some embodiments in comparison with conventional solutions; and

FIG. 7 shows a schematic cross-section of a brake disc according to some embodiments.

### DETAILED DESCRIPTION

Embodiments of the present invention provide an improved laser system for laser metal deposition and an improved method for laser metal deposition. In particular, the goal is to increase the quality, in particular the material properties, of the workpieces processed by means of laser metal deposition.

According to some embodiments, a laser system for laser metal deposition includes a laser source for generating a laser beam having a wavelength in the range between 0.4 μm and 1.5 μm. A disk laser or a fiber laser can be used as the laser source. A diode laser can also be used. In this way, for example, laser beams having wavelengths of around 450 nm, of around 515 nm, between around 800 nm and around 1000 nm, or of around 1030 nm, 1060 nm or 1070 nm can be generated. The laser beam can be designed in such a way that it can be guided to a processing head by means of an optical fiber. Owing to large usable fiber diameters, the laser beam can be satisfactorily coupled into a comparatively large ring and core portion of a multi-clad fiber, as described in more detail below, for example in the case of limited brilliance of the diode emitters or bars or stacks. The laser source can have a laser power of between 2 kW and 24 kW. If the workpiece is a brake disc, the laser power can in particular be between 8 kW and 24 kW. If the workpiece is a plain bearing, the laser power can in particular be 2 kW.

The laser system also has a jet nozzle for directing the laser beam at a workpiece surface and for directing a powder jet comprising a pulverulent material at the laser beam and at the workpiece surface. The laser beam can be directed orthogonally onto the material surface. The powder jet is inclined in relation to the laser beam in order to select an interaction zone between the powder jet and the laser beam above the material surface. Such an interaction zone allows for a more efficient deposition.

The laser beam exiting from the jet nozzle has a reduced intensity in a core region in comparison with a border region. For example, the core intensity can be less than 90% of the border intensity. Thus, at least within the interaction zone, the laser beam has an intensity in a border region which is higher than an intensity in the core region of the laser beam, so that the pulverulent material is subjected to the higher intensity of the border region when it enters the interaction zone. Due to the inclined direction of the at least one powder jet with respect to the laser beam, the interaction section with the laser beam varies over the cross-section of the powder jet. Due to the reduced intensity in the core region, the individual powder particles are supplied with a substantially homogeneous energy with a varying interaction section. In other words, an intensity maximum in the border region of the laser beam leads to a more even distribution of the fluence per powder particle and thus to an enlargement of the process window through to higher laser powers together with a more stable welding quality. For the intensity distribution of the laser beam in the focal plane, it can hold true that: I_{border}≥I_{center}≥0.

The pulverulent material comprises hard-material particles, in particular carbides, which do not dissolve after interaction with the laser beam in an interaction zone. The hard-material particles can have a powder size in the range between 15 μm and 63 μm, in particular between 15 μm and 45 μm or between 20 μm and 53 μm. The hard-material particles can comprise one or more of the following materials:

| Iron/steel | Aluminum | Nickel | Copper/bronze | Cobalt | Titanium | Others |
|---|---|---|---|---|---|---|
| 1.4404/316L | AlSi10 | Inconel | CuAl | Stellite | Ti—6Al—4V | WC in Ni |
| | | 625 | | 21 | | |
| 1.4057/431 | AlSi20/30 | Inconel | CuSn | Stellite | Ti 6246 | WC in Fe |
| | | 718 | | 12 | | |
| 1.3343/M2 | AlSi40 | Rene 41 | CuNiSi | Stellite 6 | Ti17 | TiC in Ni |
| 1.2344/H11 | AlSi10Mg | Rene N5 | CuW | Stellite 1 | TiAl | TiC in Al |
| 1.2365/H10 | | MAR | | | | |
| | | M245 | | | | |
| 1.4435 | | Hastelloy | | | | |
| | | X | | | | |
| CPM 420V | | Waspalloy | | | | |

The hard-material particles have the effect that they do not overheat when a base material, such as an iron base material of a matrix material, is heated and therefore do not dissolve. This prevents the hard-material particles from forming an alloy with the base material in a weld pool. In other words, the hard-material particles have the effect of forming a materially bonded connection with a weld pool created by the laser beam on the material surface without dissolving, for example melting. Due to the reduced core intensity of the laser beam, the hard-material particles do not form an alloy with the material or with a matrix, which means that fewer dissolved chemical elements are present. As a result, the applied layer is more resistant and fewer to no cracks, in particular vertical cracks, occur even under stress. As a result, the ductility of the workpiece is increased and the brittleness of the workpiece is reduced. Furthermore, mechanical forces can be compensated by plastic deformation.

The hard-material particles further have the effect of preventing or at least reducing the occurrence of residual stresses in the cooling phase of the weld pool, i.e., in the phase from the melt to the solid phase. In particular, the use of hard-material particles can reduce residual stresses by 25%. As a result, the distortion of the workpiece decreases during the cooling phase. The less distorted workpiece is more resistant and fewer to no cracks, in particular vertical cracks, occur even under stress. In addition, the workpiece post-processing effort is reduced due to the reduced distortion because less material has to be removed.

The use of hard-material particles thus benefits the material properties of the workpieces processed by means of laser metal deposition. For example, due to the reduced core intensity of the laser beam, 95% of the powder particles originally present in the pulverulent material are actually captured as hard-material particles in the processed workpiece.

The workpiece can be a metallic workpiece. The pulverulent material can in particular comprise a metallic material. The pulverulent material can be radiated onto the workpiece surface by means of a carrier gas, in particular argon or helium, and/or by means of an inert gas mixture as a process shielding gas. The process shielding gas can additionally shield the processing location from the surrounding atmosphere. The focus of the laser beam can be on the workpiece surface or directly above the workpiece surface. The jet nozzle can have a core opening for the laser beam with a reduced core intensity and a ring opening for the pulverulent material. The ring opening can be designed in the manner of an annular gap nozzle or by means of multiple nozzles arranged annularly around the core opening in the manner of a multi-jet nozzle. It is also possible to use wide-jet nozzles for generating a line powder focus. Here, the powder can be radiated onto the processing location at an angle from the front and/or at an angle from the rear in relation to the feed direction, for example. A powder focus can have, for example, a diameter of between 0.2 mm and approximately 6 mm. The workpiece can be, for example, a brake disc, a hydraulic cylinder, a pressure roller, a plain bearing or another rotationally symmetrical workpiece.

Furthermore, a method for laser metal deposition is proposed. The method involves the step of directing a laser beam having a wavelength in the range between 0.4 μm and 1.5 μm at a workpiece surface. It further involves the step of directing a powder jet comprising a pulverulent material at the laser beam and at the workpiece surface. The laser beam can be directed orthogonally onto the material surface. The powder jet is inclined in relation to the laser beam in order to select an interaction zone between the powder jet and the laser beam above the material surface. Such an interaction zone allows for a more efficient deposition. The laser beam and the powder jet are directed by means of the jet nozzle. The method involves the step of heating the pulverulent material in an interaction zone with the laser beam above the workpiece surface. It further involves the step of applying, in particular by means of welding, the heated pulverulent material to the workpiece surface along a predetermined contour in order to form a wear protection layer. The wear protection layer forms after cooling and is advantageous for reducing fine dust pollution on brake discs. The laser beam has a reduced intensity within the interaction zone in a core region in comparison with a border region. Furthermore, the pulverulent material comprises hard-material particles which are also present in the wear protection layer. The embodiments, effects and advantages disclosed in connection with the device are correspondingly applicable to the method.

Furthermore, a component, in particular a brake disc, a hydraulic cylinder, a pressure roller, a plain bearing or another workpiece, in particular a rotationally symmetrical workpiece, is proposed. The component has a base body made of a base material, in particular a cast alloy or cast iron. The base body can be produced by means of a forming process, such as casting. Furthermore, the base body may have undergone post-processing, such as turning or milling, before the base body is subjected to laser metal deposition. The component has a wear protection layer applied to the base body by means of laser metal deposition with a plurality of hard-material particles according to the disclosure. The wear protection layer is applied to the base body in particular using the method according to the disclosure. The wear protection layer can be designed as a two-phase or multi-phase layer system. The hard-material particles are embedded in a matrix material. The hard-material particles are preferably substantially spherical and each have an intermixing zone with the matrix material in a border region. The intermixing zone has a thickness of at most 10 μm. The reduced core intensity of the laser beam, as described above, enables such a narrow and uniform intermixing zone between hard-material particles and the matrix material over the entire wear protection layer due to the more uniform energy introduction compared to the prior art.

In one embodiment, the component is a brake disc in which the wear protection layer is applied in a braking region which is adapted to be in frictional contact with brake shoes. Due to the high strength of the hard-material particles, such a brake disc exhibits low material abrasion when the brake disc is in frictional contact with the brake shoes. This can reduce the extent of fine dust pollution during braking.

The wear protection layer can have a varying thickness along a surface of the base body, wherein a lateral thickness of the wear protection layer, i.e., a thickness at the outer border of the component, has a different extent than a medial thickness of the wear protection layer, i.e., a thickness facing the inside of the component. The thickness denotes a dimension orthogonal to the component surface. In the case of the brake disc, the thickness is orthogonal to the friction surfaces. For example, the lateral thickness of the wear protection layer can be less than the medial thickness of the wear protection layer. The wear protection layer of the adjacent component can have a plurality of hard-material particles embedded in a matrix material. The features and effects according to the disclosure can be combined with the component. The varying thickness can result from a post-processing step after laser metal deposition. For example, the high thermal input into the component during laser metal deposition can cause distortion of the component. This distortion can be more pronounced in a lateral region of the component than in a medial region. Partial removal of the wear protection layer compensates for this distortion. This can result in a lateral thickness of the wear protection layer being less than a medial thickness of the wear protection layer. In one embodiment, a difference in thickness between the medial thickness and the lateral thickness can be at most 200 μm, in particular 100 μm, further in particular at most 50 μm. In percentage terms, the difference in thickness in relation to the smallest thickness cannot be more than 40%, in particular 25%, further in particular at most 10%. Such small differences in thickness can result from the combination of a laser beam with reduced core intensity and the hard-material particles according to the disclosure. They reduce the post-processing time required for a component and benefit the material properties.

Furthermore, the component can have a buffer layer below the wear protection layer in order to implement a two-layer system.

In one embodiment, the hard-material particles of the pulverulent material comprise at least one material from the group of tungsten carbide, titanium carbide, alloys based on niobium and/or chromium carbide. Tests and experiments have shown that these materials do not overheat with the used laser beam and are therefore suitable for increasing ductility, reducing distortion and preventing crack formation.

In one embodiment, the pulverulent material has a meltable matrix material in addition to the hard-material particles so that a multi-phase layer is formed from the pulverulent material on the workpiece surface or, insofar as a method step is concerned, so that a multi-phase layer is applied to the workpiece surface. In the multi-phase layer, the hard-material particles interact with the matrix material in such a way that the multi-phase has higher-quality material properties. This supports the reduction of brittleness and helps to reduce residual stresses during the cooling phase.

In one embodiment, the hard-material particle content of the pulverulent material amounts to 15 to 40, in particular 23 to 30, volume percent. The remaining portion can be a matrix material, for example. These volume ratios represent an optimal compromise in order to achieve increased resistance in combination with an efficient bonding through laser metal deposition.

In one embodiment, the pulverulent material comprises at least one material from the group of (i) stainless steels, in particular 430L and 316L; (ii) nickel alloys, in particular corrosion-resistant nickel-based alloys; and (iii) alloys or agglomerations or powder mixtures in which at least one of the components titanium, titanium carbide, niobium, niobium carbide, molybdenum, chromium and/or chromium carbide is contained. These materials can be used in any combination with regard to a single-layer and two-layer system as well as a single-phase and multi-phase layer system. In a single-layer system, one layer of the pulverulent material is applied to the workpiece. In a two-layer system, two layers of a pulverulent material are applied to the workpiece, wherein the two layers differ from one another. For example, a first layer can be applied as a buffer layer and a second layer as a wear protection layer. In a single-phase layer system, the layer has one phase, in particular non-melted hard-material particles, while in a multi-phase layer system, the layer is divided into a matrix and hard-material particles.

In one embodiment, an outer diameter of the core region within an interaction zone is less than or equal to one third, in particular one quarter, further in particular one fifth, one eighth or one tenth, of an outer diameter of the border region. In other words, an outer diameter of the ring beam can be at most 10 times as large as the diameter of the core beam at least at one location, in particular at most 5 times, 4 times or 3 times as large. The limitations of the respective beam portions can be determined, for example, by means of the second moment method. In principle, a narrower border region results in a more uniform temperature distribution among the powder particles, as the differences in the interaction time with the laser beam are reduced. The outer diameter of the laser beam, in particular the outer diameter of the ring beam according to the variant described above, can be at least 500 μm, preferably at least 1000 μm, even more preferably at least 2000 μm at least at one location in the interaction zone. By enlarging the laser beam diameter in the interaction zone, in particular on the workpiece surface, productivity can be increased.

To generate the beam profile of the laser beam with a core region and a border region, a multi-clad fiber, in particular a 2-in-1 delivery fiber, can be used to allow for efficient beam formation. The intensity components of the core region and the ring region of the laser beam can be controllable. For example, a 2-in-1 optical fiber with a core diameter of between 200 μm and 300 μm and a ring outer diameter of between 700 μm and 1000 μm can be used. A multi-clad fiber with more than one secondary core portion can also be used, for example to generate a beam profile with different intensities in the different ring regions. In addition or alternatively, it is also possible to use beam-shaping elements, in particular a diffractive optical element (DOE) or a multi-lens array, to generate the beam profile described. In this way, non-rotationally symmetrical beam profiles, for example a linear beam profile, can also be created. Furthermore, an annular beam profile can also be created in this way using a single-core fiber.

In one embodiment, the method involves the step of applying, in particular by means of welding, a buffer material to the workpiece surface along a predetermined contour in order to form a buffer layer on the workpiece surface, wherein the buffer material is applied prior to the pulverulent material so that the buffer layer is formed below the wear protection layer. In this way, a two-layer system is implemented, which leads to an increased resistance of the workpiece.

In one embodiment, the method involves the step of partially grinding the applied pulverulent material to compensate for any distortion that has occurred during the application. The workpiece can be a brake disc. Due to thermal stresses, distortion can occur after the application of the pulverulent material in a cooling phase. The geometric component changes resulting from this distortion can be compensated for by partial grinding.

According to the disclosure, the laser beam within the interaction zone can have a beam profile with a substantially annular intensity maximum. Thus, the beam profile of the laser beam has a border region surrounding the central core region of the laser beam, in which the laser beam, preferably at every point, has a higher intensity than in the core region. The border region can also have multiple ring regions, the intensity of the laser beam within the interaction zone being higher in at least one of the ring regions than in the core region. The intensity profile can have both a graduated and a continuous form at the transitions between the regions. The intensity of the laser beam can be substantially constant along the ring shape. Alternatively, the intensity of the laser beam can be variable along the ring shape and can fluctuate by up to around 30%, for example.

Furthermore, according to the disclosure, the laser beam within the interaction zone can have a linear beam profile which is aligned substantially transversely to the feed direction of the laser beam with a leading intensity maximum in the feed direction and/or a trailing intensity maximum in the feed direction. The feed direction describes the direction in which the laser beam moves relative to the workpiece surface. It can be composed of a comparatively fast, in particular rotational feed rate of the workpiece and a comparatively slow, lateral feed rate of the processing head guiding the laser beam in order to generate a spiral-shaped or helical material application on the workpiece surface. In the case of a laser beam with a linear beam profile, the leading intensity maximum and the trailing intensity maximum each extend linearly substantially transversely to the feed direction and are spaced from one another by the likewise linear region of lower intensity (core region of the laser beam). According to this variant, the pulverulent filler material can be directed at the processing location obliquely from the front and/or obliquely from the rear by means of one or more wide-jet nozzles, which are aligned substantially parallel to the linear laser focus. The laser beam can also be composed of several separate laser beams that at least partially overlap in the focal plane.

According to the disclosure, an intensity distribution of the laser beam can be substantially plateau-shaped at one point. The plateau shape may also be referred to as a top hat. The plateau- or top hat-shaped intensity distribution describes a sudden rise in the intensity at the border of the laser beam to the intensity maximum, which is maintained substantially over the entire width of the border region, before the intensity suddenly drops back again in the direction toward the core region of the laser beam. The plateau- or top hat-shaped intensity distribution in the border region of the laser beam promotes a reduction in the roughness of the applied material layer compared to a Gaussian intensity distribution. At least at one location within the interaction zone, the intensity in the core region of the laser beam may be at most 90%, preferably at most 50%, even more preferably at most 10% of the intensity maximum in the border region of the laser beam. The intensity distribution with a lowered intensity in the core region of the laser beam makes it possible to enlarge the process window with regard to the variability of the laser power used. In particular, the described intensity distribution in the focal plane allows laser powers >4 kW to be used while maintaining the welding quality, because more laser power is used to preheat and/or melt the powder for coating the workpiece. At least at one location within the interaction zone, the power in the core region of the laser beam can be, for example, between 7% and 9% of the laser power of the overall laser beam. In the core region, it can also be between 5% and 7%, in particular around 6% of the overall power of the laser beam. According to an alternative variant, the power in the core region can be reduced to a minimum, which is to say amount in particular to 0% of the overall laser power.

Preferred exemplary embodiments are described below with reference to the figures. In this case, elements that are the same, similar or have the same effect are provided with identical reference signs in the different figures, and a repeated description of these elements is omitted in some instances, in order to avoid redundancies.

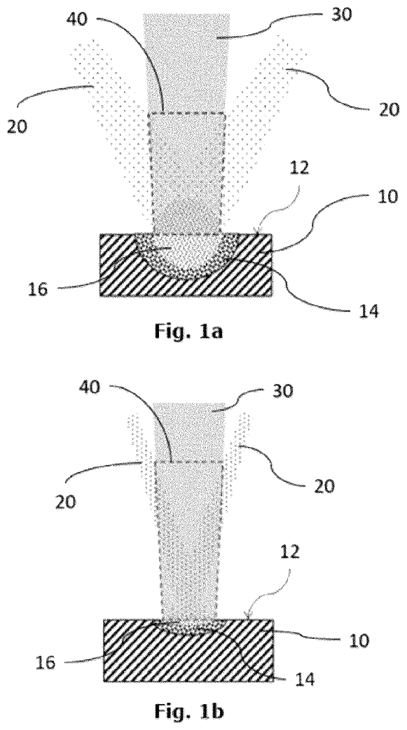

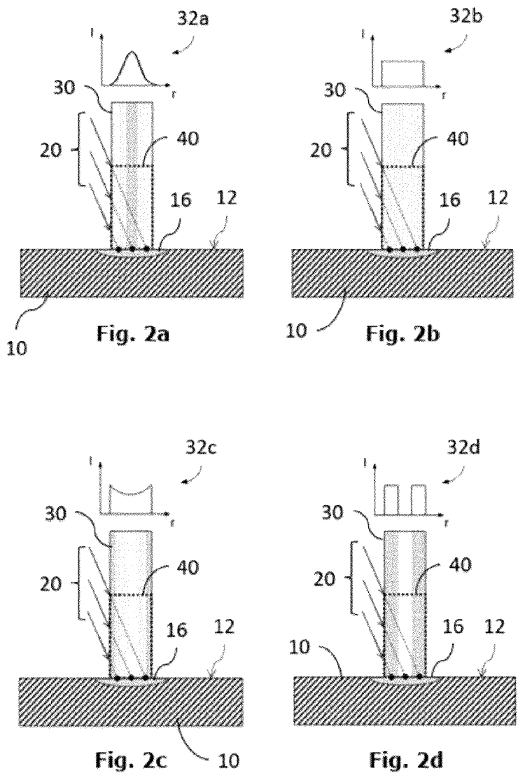

FIGS. 1a and 1b were described above. The influence of the intensity distribution of the laser beam on the interaction with the pulverulent filler material during laser metal deposition will be explained in more detail below with reference to FIGS. 2a to 2d. FIGS. 2a to 2d schematically show a sectional front view of a workpiece 10, which is locally melted by means of a laser beam 30 for the purposes of laser metal deposition, with the result that a weld pool 16 is produced on the workpiece surface 12. While the laser beam 30 is being moved over the workpiece 10 perpendicularly to the plane of the drawing, a filler material in the form of a powder jet 20 is radiated onto the processing point by means of a preferably inert carrier gas. FIGS. 2a-d each illustrate only the application of powder from one side for the sake of simplicity. However, it should be understood that, in the case of laser metal deposition, the filler material can be directed onto the processing point in multiple individual beams arranged annularly around the laser beam or in the form of a ring beam, and in the case of a linear beam profile of the laser beam for example from the front and/or from the rear in the form of a linear powder jet. Depending on the position of a powder particle within the powder jet 20, the interaction section within an interaction zone 40 along which the relevant powder particle is subjected to the laser radiation has different lengths. Correspondingly, depending on their trajectory, the powder particles are heated to different extents by the laser beam 30. While powder particles in the center of the powder jet 20 are being melted within the interaction zone 40 for example, it is possible at the same time for powder particles in the border region of the powder jet 20 to be evaporated owing to having longer or shorter interaction times with the laser beam 30 (cf. powder particles on the right or at the top in FIGS. 2a-d) or to impinge on the workpiece surface 12 in the solid state (cf. powder particles on the left or at the bottom in FIGS. 2a-d). The temperature gradient of the powder particles during laser metal deposition is great if the laser beam 30 has a Gaussian intensity profile 32a within the interaction zone 40. This case is illustrated in FIG. 2a. Powder particles at the outer (or bottom) border of the powder jet 20 are heated weakly. The inconsistent interaction time of the powder particles with the laser beam 30 can have a negative influence on the welding result. A high-quality weld bead can be ensured in a narrow process window with process parameters that are precisely matched to one another. Changes to the laser power can already lead to sensitive quality fluctuations in the welding result. An improvement in the temperature gradient and/or a narrower temperature bandwidth of the powder particles can be achieved if a laser beam 30 with a plateau- and/or top hat-shaped intensity profile 32b is used, as illustrated in FIG. 2b.

The powder can also be heated more uniformly a laser beam 30 is used, which, within the interaction zone 40, has an intensity distribution 32c, 32d according to FIGS. 2c or 2d. FIG. 2c illustrates a laser beam 30 with a concave intensity profile 32c in the interaction zone 40, in the case of which the intensity drops from an annular maximum toward the core region of the laser beam 30. Owing to the high intensity in the border region of the laser beam 30, powder particles having a short interaction time are also still heated comparatively strongly. A uniform temperature distribution of the powder particles can be achieved for a coaxial powder supply with an annular intensity profile of the laser beam 30, in the case of which most of the laser energy is present in the border region of the laser beam 30. A plateau-like and/or top hat-shaped intensity distribution 32d in the annular outer region of the laser beam 30 (cf. FIG. 2d) has been found to be favorable in this case. The use of a laser beam 30 with such an intensity distribution makes it possible to advantageously influence the process stability, in particular in the case of high-speed laser metal deposition. FIGS. 2c and 2d each relate to variants in which the laser beam 30 has a rotationally symmetrical cross-section. It should be understood that the illustrations in FIGS. 2c and 2d can be applied analogously to a laser beam 30 with a linear beam profile, wherein the respective intensity distribution 32c, 32d is then only present transversely to the length of the linear beam profile.

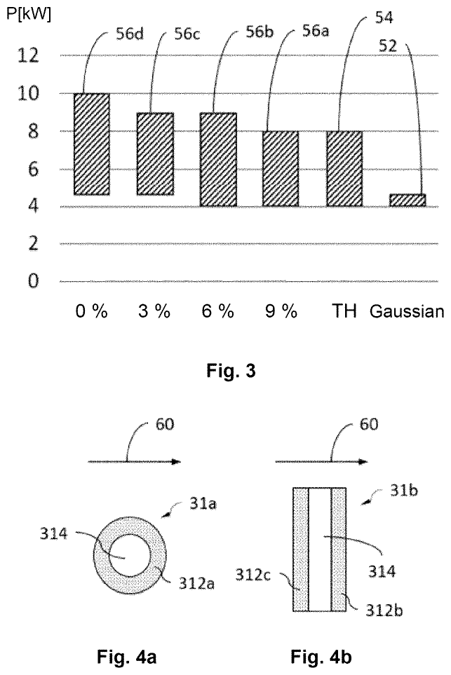

FIG. 3 shows, by way of example, the change to the process window in the case of high-speed laser metal deposition depending on the beam profile of the laser beam used. The laser powers in kW, by means of which the process can be carried out without significant losses in quality in the welding result given process parameters that are otherwise the same, are plotted in the vertical direction. The illustration relates to high-speed laser metal deposition on a tubular workpiece made of construction steel, wherein the outer diameter of the laser beam in the focal plane is 2000 μm and the feed rate is approximately 80 m/min. When a laser beam with a Gaussian beam profile (cf. FIG. 2a), i.e., with a Gaussian intensity distribution of the laser beam in the focal plane, is used, an acceptable welding result can only be achieved in a very narrow power range of 4 kW to about 4.6 kW. The process window 52 is thus very small.

In the case of a laser beam with an intensity distribution that is top hat-shaped over its entire cross-section within the interaction zone (cf. FIG. 2b), the process window 54 is already considerably larger. For the process, it is possible to use laser powers of between 4 kW and 8 kW without significant losses in quality in the welding result. The process windows 56a to 56d each relate to the use of a laser beam with an annular beam profile having a top hat-shaped intensity distribution in the annular border region of the laser beam and having a different laser power in the core region of the laser beam. In the case of a core power of 9% of the overall laser power, the process window 56a corresponds substantially to the process window 54 with a top hat-shaped intensity profile according to the illustration in FIG. 2b. In the event of a relative reduction in the laser power in the core region of the laser beam to 6% of the overall power, the laser power can be increased to 9 kW while maintaining a good welding quality. This corresponds to an enlargement of the process window 56b by 25% compared to the process window 54 with a top hat-shaped intensity profile without an annular power or intensity distribution. When the core power is reduced further to 3% of the overall power of the laser beam, losses in the degree of energy efficiency of the method can be identified. This means that good welding results can only be achieved above a laser power of approximately 4.6 kW. However, the laser powers that can be utilized with the process window 56c are 10% greater than those that can be utilized with the process window 54 when a normal laser beam with a top-hat beam profile is used. According to the illustration in FIG. 3, the largest possible process window 56d can be achieved with an annular beam profile, wherein all of the laser power is present in the ring portion, which is to say the laser power in the core beam is lowered to zero (cf. also FIG. 2d). With this beam profile, high-quality welding results can be achieved between 4.6 kW and 10 kW. This corresponds to an enlargement of the process window by 35% compared to the process window 54 when a conventional top-hat beam profile is used. The comparison according to FIG. 3 shows that the process window can be opened up to higher laser powers in the case of high-speed laser metal deposition using a laser beam with an annular intensity maximum and with coaxial supply of the pulverulent filler material in the beam focus. The findings from FIG. 3 can be transferred analogously to a laser beam with a line focus, which has a respective linear intensity maximum at its front and rear border in the feed direction within the interaction zone, wherein the pulverulent filler material is directed onto the processing point only from the front and from the rear in a linear powder jet oriented in each case substantially transversely to the feed direction.

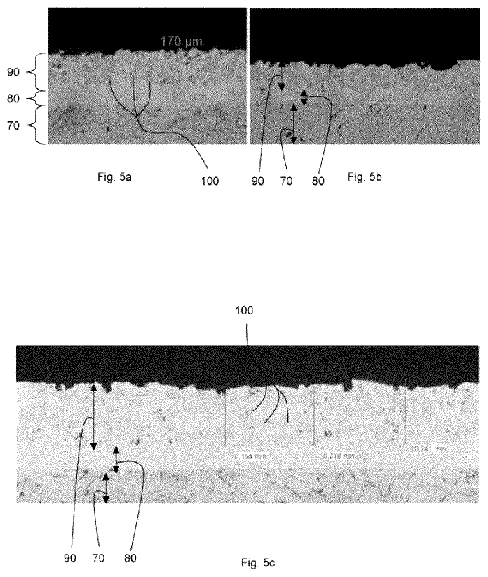

FIGS. 4a and 4b illustrate different beam profiles 31a, 31b of a laser beam 30 which respectively have a core region 314 and a border region 312a, 312b, 312c. According to embodiments of the invention, the illustrated beam profiles 31a, 31b can be in a projection plane which extends transversely to the propagation direction of the laser beam 30 and lies within the interaction zone 40 (cf FIGS. 1 and 2). The laser beam 30 according to FIG. 4a has a circular intensity maximum in its annular border region 312a and a core region 314 with an intensity lower than that of the border region 312 (cf also FIG. 2d). FIG. 4b shows a linear beam profile 31b of a laser beam 30 aligned transversely to the feed direction 60. The laser beam 30 according to FIG. 4b has a leading intensity maximum in its front border region 312b in the feed direction 60 and a trailing intensity maximum in its rear border region 312c. The core region 314 of the laser beam 30 is arranged between the straight intensity maxima and is likewise straight.

FIGS. 5a to 5c each show a cross-section of a workpiece section to which a method for laser metal deposition has been applied. The originally pulverulent material 20 was applied to a base material 70 of the workpiece. This was achieved by heating it with the laser beam 30, as described above, in order to form a materially bonded connection with the base material 70 and then letting it cool off. The base material 70 can be a cast iron or a cast alloy. FIGS. 5a to 5c show workpiece sections with different layer thicknesses, each implementing a two-layer system: In FIG. 5a, a buffer layer 80 was first applied to the base material 70 as a first layer. By way of example, this layer has a thickness of 90 μm. A wear protection layer 90 was applied as a second layer on top of the buffer layer 80. This layer contains the hard-material particles 100. In the exemplary embodiment shown in FIG. 5a, the wear protection layer 90 has a thickness of 170 μm. Because the wear protection layer 90 with the hard-material particles 100 is applied to the base material 70 with a buffer layer 80 in between, the material properties of the workpiece are improved compared to the case in which the hard-material particles 100 are applied directly to the base material 70. By increasing the wear protection layer 90 compared to the embodiment in FIG. 5b, an improved degree of resistance can be achieved. In the exemplary embodiment shown in FIG. 5b, the buffer layer 80 also has a thickness of 90 μm. The wear protection layer 90 arranged on top has a thickness of 130 μm. Due to a reduced wear protection layer 90 compared to the embodiment in FIG. 5a, higher feed rates can be achieved. In the exemplary embodiment shown in FIGS. 5a, b, a laser source with an output power of 8 kW was used by way of example, which achieves a feed rate of 145 m/min. The hard-material particles 100 have a diameter in the range between 15 μm and 63 μm, in particular between 15 μm and 45 μm or between 20 μm and 53 μm. The hard-material particles 100 are embedded in a matrix material. An intermixing zone exists between the hard-material particles 100 and the matrix material. In FIGS. 5a, 5b, the intermixing zone is recognizable as a dark rim surrounding the hard-material particles 100. The intermixing zone is small compared to the diameter of a substantially spherical hard-material particle 100. It has a thickness of at most 10 μm for the respective hard-material particle 100, in particular 8, 6, 4 or 2 μm.

FIG. 5c shows a further two-layer system. The buffer layer 80 is applied to the base material 70, to which the wear protection layer 90 is applied with a thickness in the range of approximately 190 μm to 245 μm. The wear protection layer 90 contains the hard-material particles 100. In the exemplary embodiment shown in FIG. 5c, a laser source with an output power of 10.5 kW was used by way of example. The hard-material particles 100 are formed, by way of example, from tungsten carbide. Alternatively, the materials disclosed at the outset are also conceivable. In FIGS. 5a to c, the two-layer system is free of cracks: There are no recognizable inclusions between the individual hard-material particles 100 or at other locations. This increases the ductility and reduces the brittleness of the workpiece. For example, due to the reduced core intensity of the laser beam, 95% of the powder particles originally present in the pulverulent material 20 are actually captured as hard-material particles in the processed workpiece.

The use of hard-material particles 100 has the effect that they do not overheat when the base material 70 is heated and thus do not dissolve. It is therefore avoided that the hard-material particles 100 form an alloy with the base material 70 or bring about air inclusions, which would increase the residual stresses in the base material 70. The residual stresses lead to distortion due to a shielding effect when the workpiece cools down. FIG. 6 compares the distortion in the case of laser metal deposition according to the disclosure with a conventional laser metal deposition. The use of hard-material particles 100 reduces the residual stresses that occur. As a result, the distortion of the workpiece during cooling is reduced, for example by 24%. This increases the quality of the workpiece and reduces the amount of material to be removed after distortion, which is beneficial with respect to material utilization.

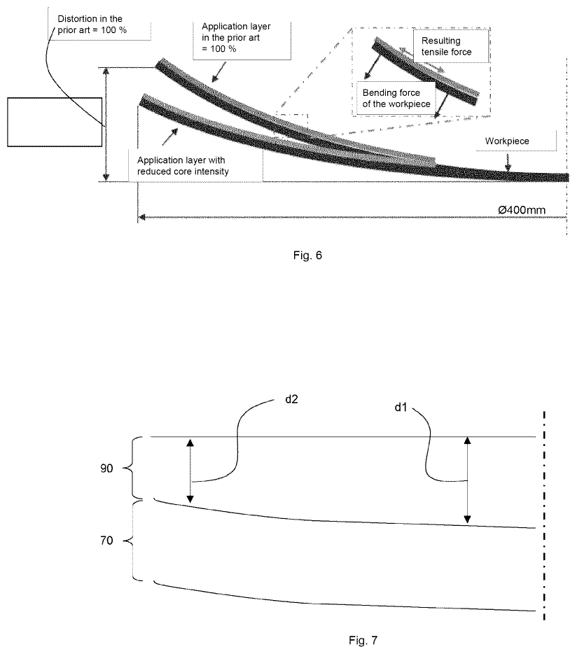

FIG. 7 shows a cross-section of a rotationally symmetrical component, in particular a brake disc, after a wear protection layer 90 has been applied by means of laser metal deposition and after grinding has been carried out. A medial thickness d1 of the wear protection layer 90 is greater than a lateral thickness d2. This means that more material was removed from the medial region of the wear protection layer 90 than from the lateral region, which had substantially the same thickness as the medial region before grinding. The reason for this is that the shielding effect in the lateral region of the component leads to greater distortion than in the medial region. The brake disc is a rotationally symmetrical component. The medial region is therefore a radially inner region, the lateral region a radially outer region. The reduced core intensity in combination with the hard-material particles means that the difference between the radially inner thickness d1 and the radially outer thickness d2 is at most 200 μm, in particular 100 μm, further in particular at most 50 μm. In percentage terms, the difference in thickness in relation to the smallest thickness cannot be more than 40%, in particular 25%, further in particular at most 10%.

Insofar as applicable, all individual features presented in the exemplary embodiments may be combined with one another and/or interchanged, without departing from the scope of the invention.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A laser system for laser metal deposition, the laser system comprising:
a laser source for generating a laser beam having a wavelength in a range between 0.4 μm and 1.5 μm; and
a jet nozzle for directing the laser beam at a workpiece surface and for directing a powder jet comprising a pulverulent material at the laser beam and at the workpiece surface;
wherein the laser beam exiting from the jet nozzle has a reduced intensity in a core region in comparison with a border region; and
wherein the pulverulent material comprises hard-material particles.

2. The laser system according to claim 1, wherein
the hard-material particles of the pulverulent material comprise at least one of tungsten carbide, titanium carbide, alloys based on niobium, or chromium carbide.

3. The laser system according to claim 1, wherein
the pulverulent material further comprises a meltable matrix material in addition to the hard-material particles so that a multi-phase layer is formed from the pulverulent material on the workpiece surface.

4. The laser system according to claim 1, wherein
a hard-material particle content of the pulverulent material amounts to 15 to 40 volume percent.

5. The laser system according to claim 1, wherein
the pulverulent material comprises at least one of
stainless steels;
nickel alloys; or
alloys or agglomerations or powder mixtures which contain at least one of titanium, titanium carbide, niobium, niobium carbide, molybdenum, chromium or chromium carbide.

6. The laser system according to claim 1, wherein
an outer diameter of the core region is less than or equal to one third of an outer diameter of the border region.

7. A method for laser metal deposition comprising:
directing a laser beam having a wavelength in a range between 0.4 μm and 1.5 μm at a workpiece surface;
directing a powder jet comprising a pulverulent material at the laser beam and at the workpiece surface;
heating the pulverulent material in an interaction zone with the laser beam at least partially above the workpiece surface; and
applying, by deposition welding, the heated pulverulent material to the workpiece surface along a predetermined contour in order to form a wear protection layer;
wherein the laser beam has a reduced intensity within the interaction zone in a core region in comparison with a border region; and
wherein the pulverulent material comprises hard-material particles which are present in the wear protection layer.

8. The method according to claim 7, wherein
the hard-material particles of the pulverulent material comprise at least one of tungsten carbide, titanium carbide, alloys based on niobium, or chromium carbide.

9. The method according to claim 7, wherein
the pulverulent material further comprises a meltable matrix material in addition to the hard-material particles so that a multi-phase layer is applied to the workpiece surface.

10. The method according to claim 7, wherein
a hard-material particle content of the pulverulent material amounts to 15 to 40 volume percent.

11. The method according to claim 7, wherein
the pulverulent material comprises at least one of
stainless steels;
nickel alloys; or
alloys or agglomerations or powder mixtures which contain at least one of titanium, titanium carbide, niobium, niobium carbide, molybdenum, chromium or chromium carbide.

12. The method according to claim 7, wherein
an outer diameter of the core region is less than or equal to one third of an outer diameter of the border region.

13. The method according to claim 7, further comprising:
applying, by deposition welding, a buffer material to the workpiece surface along a predetermined contour in order to form a buffer layer on the workpiece surface;
wherein the application of the buffer material is performed prior to the application of the pulverulent material so that the buffer layer is formed below the wear protection layer.

14. The method according to claim 7, further comprising:
partially grinding the applied pulverulent material to compensate for any distortion that has occurred during the application.

15. A component comprising:
a base body made of a base material; and
a wear protection layer applied to the base body and comprising a plurality of hard-material particles embedded in a matrix material;
wherein the wear protection layer is applied by the method according to claim 7;
wherein the hard-material particles have, in a border region, an intermixing zone with the matrix material which has a thickness of at most 10 μm.

16. The component according to claim 15, wherein
the component is a brake disc in which the wear protection layer is applied in a braking region adapted to be in frictional contact with brake shoes.

17. The component according to claim 15, wherein
the wear protection layer has a varying thickness along a surface of the base body, wherein a lateral thickness of the wear protection layer is different from a medial thickness of the wear protection layer.

18. The component according to claim 17, wherein
a difference between the medial thickness and the lateral thickness is at most 200 μm.

19. The component according to claim 15, wherein
a buffer layer that is free of hard-material particles is arranged below the wear protection layer.
